(19) United States
(12) Patent Application Publication
(10) Pub. No.: US 2026/0207000 A1
(43) Pub. Date: Jul. 23, 2026

(54) Food Heating Appliance With A Lid Equipped With A Thermal Shield Portion

(71) Applicant: SEB S.A., Ecully (FR)

(72) Inventors: Hanae Bellance, Ecully Cedex (FR); Loïc Blandin, Ecully Cedex (FR); Anaïs Dujardin, Ecully Cedex (FR); Fabrice Renault, Ecully Cedex (FR); Fabien Russier, Ecully Cedex (FR); Quentin Dos Santos, Ecully Cedex (FR)

(73) Assignee: SEB S.A., Ecully (FR)

(21) Appl. No.: 19/442,787

(22) Filed: Jan. 7, 2026

Related U.S. Application Data
(63) Continuation of application No. PCT/FR2024/050887, filed on Jul. 2, 2024.

(30) Foreign Application Priority Data
Jul. 7, 2023 (FR) FR2307276

(51) Int. Cl. A47J 36/24; A47J 36/06; A47J 36/38

(52) U.S. Cl. CPC A47J 36/2483; A47J 36/06; A47J 36/38

(57) ABSTRACT

A food-heating appliance includes a base with a receiving surface; a bowl resting on the receiving surface and delimiting an internal volume intended to contain food. The bowl includes an upper peripheral edge; and a lid supported by the base and configured to sit on top of the bowl, the lid having an upper heating element configured to heat, at least by radiation, the food contained in the bowl, the lid including a thermal shield portion configured to be arranged inside the bowl so that the upper peripheral edge of the bowl is not directly subjected to radiation from the upper heating element.

### CROSS REFERENCE TO RELATED APPLICATIONS

The present application is a continuation of International Application No. PCT/FR2024/050887, filed on Jul. 2, 2024, which claims priority from French Patent Application No. FR2307276 filed on Jul. 7, 2023, all of which are hereby incorporated herein by reference.

### TECHNICAL FIELD

The present invention generally relates to an appliance for heating food products, in particular for cooking them.

### BACKGROUND OF THE INVENTION

Conventionally, an electric cooking appliance comprises:
a housing comprising a cooking vessel that delimits a cooking chamber intended to hold food;
a lid mounted movably relative to the housing between an open position, in which the lid allows access to the cooking chamber, and a closed position, in which the lid prevents access to the cooking chamber; and
a heating element attached to the lid and configured to be positioned above the cooking chamber delimited by the cooking vessel when the lid is in the closed position.

Such an electric cooking appliance allows food contained in the cooking chamber to be cooked using various cooking modes.

However, once the food contained in the cooking chamber of such an electric cooking appliance has been cooked, the user must transfer the food to another container, such as a plate or serving dish, for consumption. This is particularly due to the fact that the shape, size, volume, and high temperature of the external surfaces of the cooking vessel are not suitable for consuming food directly from the cooking vessel. Thus, using such an electric cooking appliance requires at a minimum the cleaning of the cooking vessel and the container used, which can be tedious for the user.

Therefore, a user may be discouraged from using an electric cooking appliance of the aforementioned type for cooking small quantities of food, for example, when preparing a meal for a single person.

Furthermore, when cooking food in an electric cooking appliance of the aforementioned type, the upper peripheral edge of the cooking vessel is directly subject to the radiation emitted by the heating device attached to the lid, and therefore reaches a relatively high temperature at the end of cooking. This requires the user to exercise particular caution to avoid getting burned when handling the cooking vessel, especially when lifting the cooking vessel or attempting to retrieve the food contained in the cooking vessel with a spoon.

### SUMMARY OF THE INVENTION

The present invention aims to remedy these disadvantages.

The technical problem underlying the invention therefore consists in providing a food-heating appliance that is simple and economical in structure, allows easy and rapid heating and/or cooking of food, while allowing safe consumption of food directly from a heating and/or cooking utensil integrated with the food-heating appliance.

To this end, the present invention relates to a food-heating appliance comprising:
a base with a receiving surface,
a removable bowl configured to rest on the receiving surface of the base, the bowl comprising a bottom and a side wall that delimit an internal volume intended to contain food, the side wall of the bowl comprising an upper peripheral edge delimiting an upper opening through which food can be introduced into the internal volume of the bowl,
a lid supported by the base and configured to sit on top of the bowl when the bowl rests on the receiving surface, the lid comprising an upper heating element configured to heat at least by radiation, and more particularly by infrared radiation, food contained in the bowl,
the lid comprising a thermal shield portion configured to be positioned, and in particular to protrude, inside the bowl when the bowl rests on the receiving surface so that the upper peripheral edge of the bowl is not directly subjected to radiation from the upper heating element.

The specific configuration of the lid, and more particularly the fact that it is equipped with the upper heating element and the thermal shield portion, allows for optimal heating and/or cooking of the food contained in the bowl while avoiding excessive heating of the upper peripheral edge of the bowl.

Thus, after heating and/or cooking food, the user can safely grasp the bowl resting on the receiving surface of the base for consumption of the meal, without necessarily requiring the presence of handles on the bowl, which would have the disadvantage of increased manufacturing costs of the bowl and added bulk and limited possible relative angular positions between the bowl and the receiving surface. Moreover, the user can safely consume the meal directly from the bowl used to cook it, without the risk of burns from contact with the upper peripheral edge of the bowl, due to its low temperature.

The food-heating appliance according to the invention thus allows for easy and rapid preparation of a meal, while allowing safe consumption of the meal directly from the bowl used to cook it, thereby reducing the number of utensil the user needs to wash.

The food-heating appliance may further include one or more of the following features, taken individually or in combination.

According to one embodiment of the invention, the thermal shield portion is configured to extend at least partially downward when the food-heating appliance is being used.

According to one embodiment of the invention, the thermal shield portion is configured to allow heating of the food contained in the cooking vessel by the upper heating element when the lid is in the closed position.

According to one embodiment of the invention, the thermal shield portion extends around the upper heating element.

According to one embodiment of the invention, when the food-heating appliance is being used, the thermal shield portion and the receiving surface are spaced apart from each other by a separation distance that is less than the height of the bowl. Thus, the thermal shield portion is at least partially inserted into the internal volume of the bowl when the food-heating appliance is being used (and in particular when the lid is in the closed position), thereby reducing the volume of the cooking and/or heating chamber positioned inside the bowl. Such a feature allows for more efficient cooking or heating. Such a feature also prevents the user from inserting their hand into the bowl and avoids burns from contact with the underside of the lid.

According to one embodiment of the invention, the upper heating element comprises an electric heating resistor.

According to one embodiment of the invention, the upper heating element is configured to extend facing the bottom of the bowl when the food-heating appliance is being used and the bowl is resting on the receiving surface.

According to one embodiment of the invention, the lid comprises a lid body comprising the thermal shield portion.

According to one embodiment of the invention, the thermal shield portion is configured to extend between the upper peripheral edge of the bowl and the upper heating element. Such an arrangement of the thermal shield position further limits the risks of heating the upper peripheral edge of the bowl.

According to one embodiment of the invention, the thermal shield portion comprises an external circumferential surface configured to extend facing an inner circumferential surface of the bowl, and more particularly facing an inner circumferential surface of an upper part of the side wall of the bowl.

According to one embodiment of the invention, the thermal shield portion has an overall cylindrical shape.

According to one embodiment of the invention, the food-heating appliance is configured such that, when the food-heating appliance is being used and the bowl is resting on the receiving surface, a central axis of the thermal shield portion is substantially aligned with a central axis of the bowl.

According to one embodiment of the invention, the thermal shield portion has an external diameter that is smaller than the internal diameter of the upper peripheral edge of the bowl.

According to one embodiment of the invention, the thermal shield portion and the bowl are configured to delimit a space, advantageously annular, extending around the thermal shield portion. Such a configuration of the lid facilitates insertion of the thermal shield portion into the bowl and positions the hot portion of the lid away from the upper peripheral edge of the bowl, and therefore further limits the risks of heating the upper peripheral edge of the bowl.

According to one embodiment of the invention, the space has a width, measured along a radial direction with respect to a central axis of the bowl, between 2 mm and 4 cm, and for example between 2 mm and 1 cm.

According to one embodiment of the invention, the lid comprises a peripheral sealing portion configured to cooperate, for example in a sealed manner, with the bowl so as to prevent the flow of hot air between the upper peripheral edge of the bowl and the thermal shield portion. Such a lid configuration further limits the risks of heating the upper peripheral edge of the bowl.

According to one embodiment of the invention, the lid comprises a protective element, such as a protective plate or grid, configured to prevent a user from accessing the upper heating element, the protective element being configured to extend under the upper heating element when the food-heating appliance is in use. The presence of the protective element reduces the risk of deterioration of the upper heating element by protecting it against food splashes. Advantageously, the protective element is mounted removably on the lid to facilitate its cleaning.

According to one embodiment of the invention, the protective element is essentially transparent to the wavelengths of the radiation emitted by the upper heating element. Thus, the protective element does not interfere with the cooking of food by the radiation emitted by the upper heating element.

According to one embodiment of the invention, the base comprises a lower heating device configured to heat food contained in the bowl when the bowl rests on the receiving surface. The presence of such a lower heating device makes it possible to increase the number of recipes that can be made with the food-heating appliance according to the present invention.

The lower heating device may, for example, be housed in a main housing of the base and may, for example be positioned under the receiving surface.

According to one embodiment of the invention, the lower heating device is an induction heating device. For example, the induction heating device may include an induction coil configured to generate a magnetic field when the induction coil is electrically powered.

According to one embodiment of the invention, the base comprises a centering element protruding upwards from the receiving surface, and the bowl comprises a centering housing leading to a lower surface of the bowl and configured to receive the centering element when the bowl is resting on the receiving surface. The centering element and the centering housing ensure optimal positioning of the bowl with respect to the receiving surface, and in particular with respect to the induction heating device when the food-heating appliance is equipped with such an induction heating device.

According to one embodiment of the invention, the lid comprises a steam exhaust chimney configured to evacuate, towards the outside of the food-heating appliance, the steam generated in the internal volume of the bowl. The presence of such a steam exhaust chimney reduces the steam pressure in the bowl, and therefore the risk of steam escaping by the upper peripheral edge of the bowl, which further limits the risk of heating the upper peripheral edge of the bowl.

According to one embodiment of the invention, the steam exhaust chimney comprises a first chimney end leading into an underside of the lid and a second chimney end leading into an upper side of the lid.

According to one embodiment of the invention, the steam exhaust chimney is arranged in a central part of the lid, and leads, for example, to a central part of the underside of the lid. Such a placement of the chimney further limits the risks of heating the upper peripheral edge of the bowl.

According to one embodiment of the invention, the steam exhaust chimney is configured to extend substantially vertically when the food-heating appliance is being used.

According to one embodiment of the invention, the upper heating element extends at least partially around the steam exhaust chimney.

According to one embodiment of the invention, the lid comprises a lid insert that is removably mounted in the steam exhaust chimney. Such a characteristic allows the degree of steam confinement inside the bowl to be adjusted and therefore adapting the cooking mode according to the desired result. The removability of the lid insert also makes it possible to add ingredients during cooking, through the steam exhaust chimney, without opening the lid, and to manually stir the contents of the bowl using a tool that can be inserted into the steam exhaust chimney, such as a spoon. It also allows visual access to the inside of the bowl and in particular to visually check the level of cooking.

According to one embodiment of the invention, the lid insert comprises a tubular steam-guiding portion configured to be fluidly connected to the internal volume of the bowl, and an upper end wall that partially closes one upper end of the steam-guiding portion, the upper end wall being provided with at least one steam evacuation opening.

According to one embodiment of the invention, the bowl comprises a bowl body, advantageously metallic, delimiting at least part of the internal volume of the bowl and comprises at least one thermally insulating layer that envelops at least part of the bowl body.

According to one embodiment of the invention, the thermally insulating layer comprises a thermal insulation coating which is made of thermally insulating material, for example elastomer, which covers at least part of an external surface of the bowl body.

According to one embodiment of the invention, the bowl body is metallic and has a bottom wall and a peripheral wall extending from the bottom wall. Such a configuration of the bowl allows, on the one hand, optimal cooking of the foods contained in the bowl since these foods are in contact with the metallic bowl body, and whose thermal conduction promotes the cooking of food, and, on the other hand, easy and safe handling of the bowl since the presence of the thermal insulation coating prevents direct contact between the fingers and/or hands of the user and the bowl body whose temperature is relatively high at the end of cooking.

According to one embodiment of the invention, the thermal insulation coating is molded independently of the bowl body and is then fitted to the latter by being attached through the folding of a metallic element carried by the bowl body or by bonding.

According to one embodiment of the invention, the thermal insulation coating is applied to the bowl body by overmolding.

According to one embodiment of the invention, the thermal insulation coating is removably attached to the bowl body.

According to one embodiment of the invention, the thermal insulation coating comprises an underside configured to rest on the receiving surface. Such a configuration of the thermal insulation coating allows the bowl, after being removed from the receiving surface at the end of cooking, to be placed directly on a temperature-sensitive support and/or to be supported by its underside without risk of burns.

According to one embodiment of the invention, the induction heating device comprises a temperature sensor configured to monitor the temperature of the bowl body.

According to one embodiment of the invention, the temperature sensor forms the centering element.

According to one embodiment of the invention, the thermally insulating material is substantially transparent to the magnetic field generated by the induction heating device.

According to one embodiment of the invention, the thermal insulation coating covers at least part of an outer surface of the peripheral wall of the bowl body and at least part of an outer surface of the bottom wall of the bowl body.

According to one embodiment of the invention, the thermal insulation coating completely covers the outer surface of the peripheral wall of the bowl body. Such a bowl configuration significantly limits a user's risk of burns when handling the bowl.

According to one embodiment of the invention, the thermal insulation coating covers an upper end of the bowl body, and more particularly the peripheral wall of the bowl body, and at least partially delimits the upper opening of the bowl. Such a bowl configuration further limits a user's risk of burns when handling the bowl or consuming foods contained therein.

According to one embodiment of the invention, the thermal insulation coating completely delimits the upper opening of the bowl.

According to one embodiment of the invention, the thermal insulation coating partially covers an inner surface of the peripheral wall of the bowl body, and for example, partially covers an inner surface of an upper end portion of the peripheral wall of the bowl body. Such a bowl configuration further limits a user's risk of burns when consuming foods contained in the bowl.

According to one embodiment of the invention, the thermal insulation coating extends over a height of at least 1.5 cm, and advantageously a height of at least 2 cm, above the upper end of the peripheral wall of the bowl body. Such a characteristic makes it possible to limit heating in the upper part of the bowl due to the absence of the metallic peripheral wall of the bowl body in this area. Such a configuration thus limits the risk of burns for a user who grips the bowl by the upper end of the peripheral wall with their thumb. Such a feature also allows for a deformable upper end of the bowl thus providing a good sealing between the lid and the bowl once the lid is in the closed position.

According to one embodiment of the invention, an upper end portion of the peripheral wall of the bowl body delimits a retaining housing, for example annular, provided with an insertion opening, for example annular, leading into an internal volume of the bowl body, and the thermal insulation coating comprises a retaining part, for example annular, which is received and retained in the retaining housing. Such a configuration of the bowl ensures a durable and secure attachment of the thermal insulation coating to the bowl body, which considerably limits the risk of separation of the thermal insulation coating from the bowl body and therefore of deterioration of the bowl.

According to one embodiment of the invention, the thermal insulation coating comprises a lower opening located above the bottom wall of the bowl body and configured to expose a central portion of the bottom wall of the bowl body.

According to one embodiment of the invention, the temperature sensor is configured to extend through the lower opening when the bowl is resting on the receiving surface, and for example to be in contact with the bottom wall of the bowl body.

According to one embodiment of the invention, the bowl comprises a metallic insert configured to border the lower opening provided in the thermal insulation coating. Such a metallic insert ensures a mechanical attachment of the thermal insulation coating on the edge of the lower opening. In particular, the metallic insert comprises a part which, during a first phase of the bowl manufacturing process, is inserted into the lower opening and then, during a second phase, is bent against the underside of the thermal insulation coating to clamp the thermal insulation coating. Such a characteristic ensures a watertight connection between the insert and the thermal insulation coating, avoiding water infiltration, particularly when washing the bowl.

According to one embodiment of the invention, the thermal insulation coating is attached to the metallic insert, for example by overmolding.

According to one embodiment of the invention, the lower heating device is a convection heating device, a conduction heating device or a radiation heating device, for example by infrared radiation. According to such an embodiment of the invention, the lower wall of the bowl body is exposed, i.e. not covered by the thermal insulation coating, to allow heating of the bowl body by the lower heating device.

According to one embodiment of the invention, the lid is movable between a closed position in which the lid is configured to cover the bowl and prevent access to the internal volume of the bowl when the bowl is resting on the receiving surface, and an open position in which the lid is configured to allow access to the internal volume of the bowl when the bowl is resting on the receiving surface. Such a configuration of the lid allows easy positioning of the bowl on the receiving surface, and also easy removal of the bowl from the receiving surface, when the lid is in the open position, further enhancing the ergonomics of the food-heating appliance according to the present invention.

According to one embodiment of the invention, the food-heating appliance is in use when the lid is in the closed position.

According to one embodiment of the invention, in the closed position, the lid does not rest on the upper edge of the side wall of the bowl. In other words, there is a space between the upper edge of the side wall of the bowl and the lower surface of the lid which faces it. Such a characteristic limits the heating of the upper edge of the bowl by avoiding thermal transfer through conduction between the lid and the bowl.

According to one embodiment of the invention, the open position of the lid is stable.

According to one embodiment of the invention, the lid is pivotably mounted relative to the base around a pivot axis, which may, for example, be located at the rear part of the base. Advantageously, the pivot axis extends substantially horizontally when the base is resting on a horizontal surface.

According to another embodiment of the invention, the lid is fixed and is located opposite the receiving surface provided on the base.

According to one embodiment of the invention, the base comprises a main housing on which the receiving surface is provided, and a support structure that extends in height from the main housing and is configured to support the lid, the support structure being configured to extend only along part of the periphery of the bowl when the bowl is resting on the receiving surface of the base.

According to one embodiment of the invention, the support structure is configured to provide an access opening extending over at least 180°, and for example over at least 220°, of the periphery of the bowl when the bowl is resting on the receiving surface. Such a configuration of the access opening allows a user, wishing to remove the bowl from the receiving surface at the end of cooking, to firmly grasp the bowl with both hands and therefore to transport it safely to the dining location. Such a configuration of the access opening also allows the bowl to be positioned on the receiving surface, and similarly removed from the receiving surface, in various angularly offset orientations, thereby enhancing the ergonomics of the food-heating appliance according to the present invention.

Advantageously, the access opening is configured to allow access to the bowl resting on the receiving surface from a first lateral side of the food-heating appliance and from a second lateral side of the food-heating appliance.

According to one embodiment of the invention, the access opening has a height greater than the height of the bowl.

According to one embodiment of the invention, the support structure is curved and extends substantially over an angular sector centered on a central vertical axis of the base and having an angle between 10° and 180°, and advantageously between 20° and 140°, and for example between 30°and 120°.

According to one embodiment of the invention, the support structure has a cross-section, according to a plane perpendicular to the central vertical axis of the base, which is substantially arc-shaped.

According to one embodiment of the invention, the support structure is located in a rear part of the base.

According to one embodiment of the invention, the support structure is configured to extend substantially vertically when the food-heating appliance is resting on a horizontal surface.

According to one embodiment of the invention, the internal volume of the bowl is less than 1.3 liters, and for example less than 1 liter. Such a bowl configuration ensures efficient and rapid cooking of the food contained in the bowl, provides high compactness for the food-heating appliance according to the invention, and encourages a user to use the food-heating appliance for the preparing a meal for a single person.

According to one embodiment of the invention, the lid comprises a prominent gripping part that is configured to be grasped by a user when moving the lid between the open position and the closed position. The prominent gripping part is configured to protrude, for example radially, beyond the side wall of the bowl when the food-heating appliance is in use and the bowl is resting on the receiving surface. Such a configuration of the food-heating appliance according to the invention allows a user wishing to move the lid to the open position to firmly grasp the lid by the prominent gripping part, which is located away from the hot part of the lid, and thus subsequently manipulate the lid safely. The presence of the prominent gripping part thus significantly limits the user's risk of burns when handling the lid.

Protruding beyond the side wall of the bowl means that the prominent gripping part horizontally extends from the side wall of the bowl and protrudes towards the outside of the food-heating appliance.

Advantageously, the prominent gripping part is configured to protrude beyond the side wall of the bowl with a protrusion distance greater than 1 cm, and for example greater than 2 cm.

According to one embodiment of the invention, the prominent gripping part extends over at least part of the perimeter of the lid.

According to one embodiment of the invention, the prominent gripping part is located at least partially in a front part of the lid, i.e. a part of the lid intended to face a user situated in front of the food-heating appliance.

According to one embodiment of the invention, the prominent gripping part extends from a first lateral side of the lid to a second lateral side of the lid through the front part of the lid.

According to one embodiment of the invention, the prominent gripping part has an underside, for example substantially flat, which is configured to be located at least partly above the upper peripheral edge of the bowl when the food-heating appliance is in use and the bowl is resting on the receiving surface.

According to one embodiment of the invention, the receiving surface is substantially circular.

According to one embodiment of the invention, the receiving surface is flat.

According to one embodiment of the invention, the lid comprises a reflector configured to deflect at least part of the radiation from the upper heating element to the bowl when the food-heating appliance is in use and the bowl is resting on the receiving surface.

According to one embodiment of the invention, the reflector is configured to extend above the upper heating element when the food-heating appliance is in use.

According to one embodiment of the invention, the reflector and the protective element delimit an internal housing, for example an annular housing, in which the upper heating element is arranged.

According to one embodiment of the invention, the bowl has no gripping handle.

According to one embodiment of the invention, the food-heating appliance comprises a single bowl.

According to one embodiment of the invention, the food-heating appliance comprises a fan mechanically connected to the lid and configured to generate an airflow, the upper heating element being configured to heat the airflow generated by the fan. Thus, the food-heating appliance according to the present invention allows cooking food contained in the bowl using a hot-air cooking method.

According to one embodiment of the invention, the lower heating element has a power of less than 1,200 W, and preferably less than 800 W.

According to one embodiment of the invention, the upper heating element has a power of less than 1,200 W, preferably less than 800 W, and advantageously between 300 W and 500 W.

According to one embodiment of the invention, the lower heating element has a power greater than that of the upper heating element.

### BRIEF DESCRIPTION OF THE FIGURES

The present invention will be better understood with reference to the following description and the appended figures, in which identical reference signs correspond to structurally and/or functionally identical or similar elements.

FIG. 1 is a perspective view of a food-heating appliance according to the invention.

FIG. 2 is a front view of the food-heating appliance in FIG. 1.

FIG. 3 is a side view of the food-heating appliance in FIG. 1.

FIG. 4 is a longitudinal sectional view of the food-heating appliance in FIG. 1.

FIG. 5 is an enlarged view of a detail in FIG. 4.

FIG. 6 is a perspective view of the food-heating appliance in FIG. 1, in which a bowl of the food-heating appliance was removed.

FIG. 7 is a perspective view of the food-heating appliance in FIG. 1, showing a lid in the open position.

FIG. 8 is a perspective view of the food-heating appliance in FIG. 1, showing the lid in the open position and in which the bowl was removed.

FIG. 9 is a truncated perspective view of the food-heating appliance in FIG. 1, showing the lid in the open position.

FIG. 10 is a perspective view of the bowl of the food-heating appliance in FIG. 1.

FIG. 11 is a longitudinal sectional view of the bowl in FIG. 10.

FIG. 12 is an enlarged view of a detail in FIG. 11.

### DETAILED DESCRIPTION

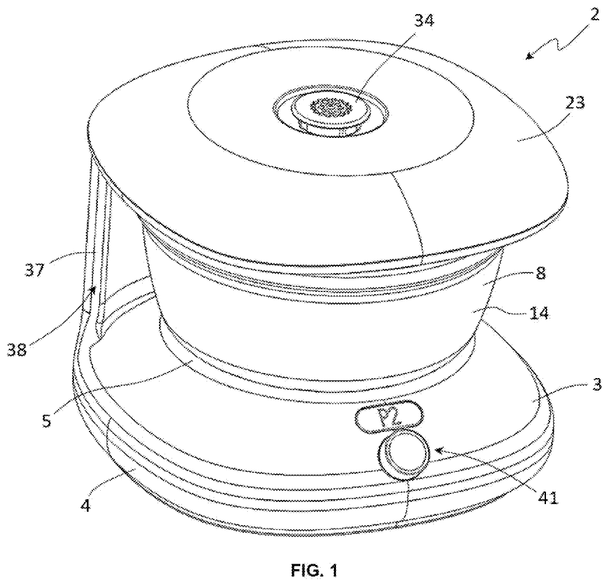

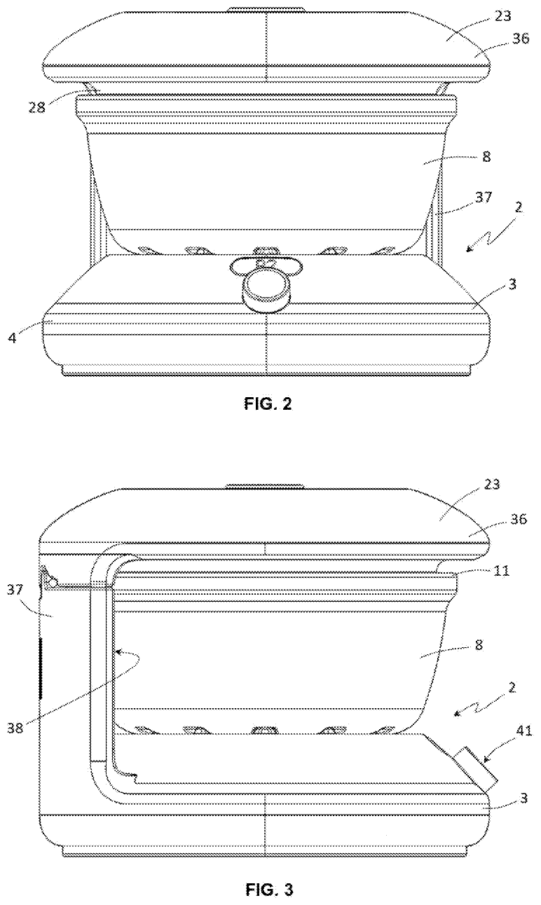

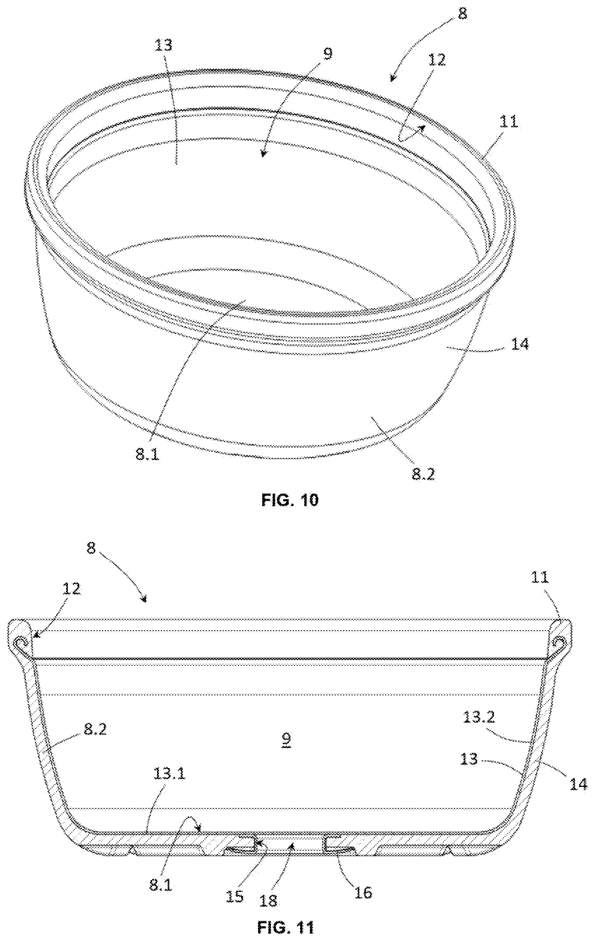

FIGS. 1 to 12 represent a food-heating appliance 2, and more specifically an electric cooking appliance, for cooking food such as meat, fish, vegetables, rice etc.

The food-heating appliance 2 has a base 3 configured to rest on a flat support, such as a countertop. The base 3 has a main housing 4 with a receiving surface 5. Advantageously, the receiving surface 5 is flat and circular.

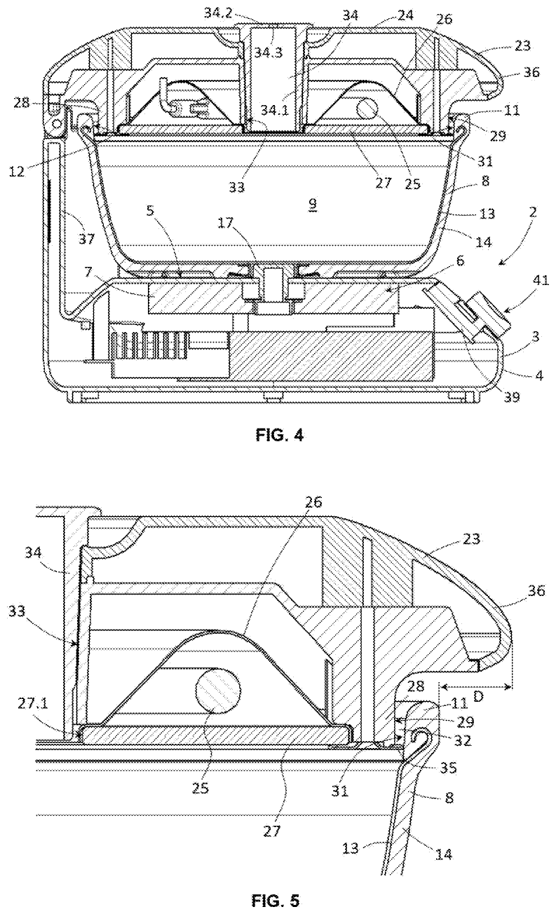

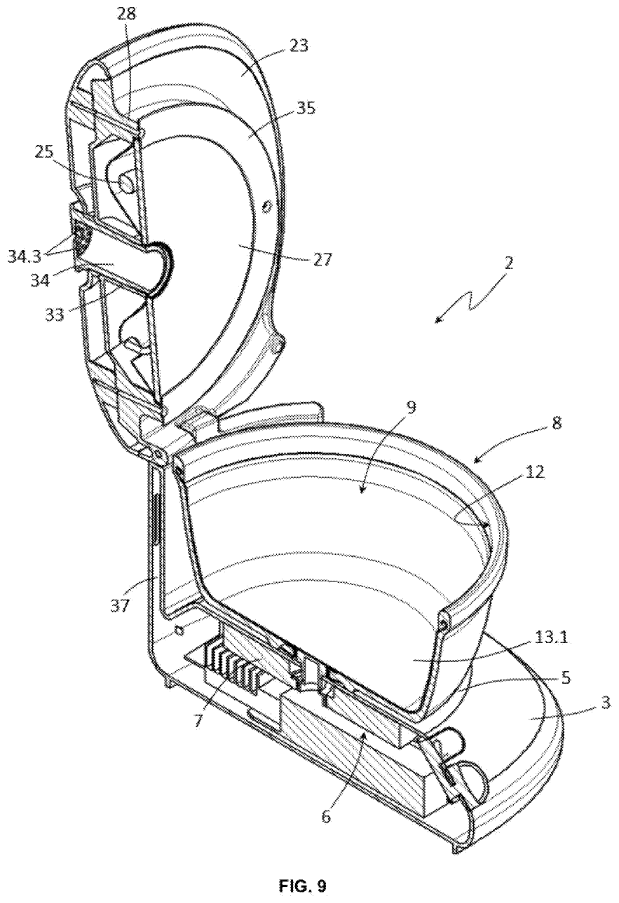

According to the embodiment shown in the figures, the base 3 comprises a lower heating device 6 (see FIGS. 4 and 9) housed in the main housing 4. Advantageously, the lower heating device 6 is an induction heating device, and comprises an induction coil 7 which is located below the receiving surface 5 and configured to generate a magnetic field when the induction coil 7 is electrically powered.

The food-heating appliance 2 also has a bowl 8 which is removable and configured to rest on the receiving surface 5 of the base 3, and to be heated in particular by the lower heating device 6. The bowl 8 delimits an internal volume 9 intended to contain food. Advantageously, the internal volume 9 of the bowl 8 is less than 1 liter.

The bowl 8 further comprises a bottom 8.1 and a side wall 8.2 provided with an upper peripheral edge 11 delimiting an upper opening 12 through which food can be introduced into the internal volume 9 delimited by the bowl 8.

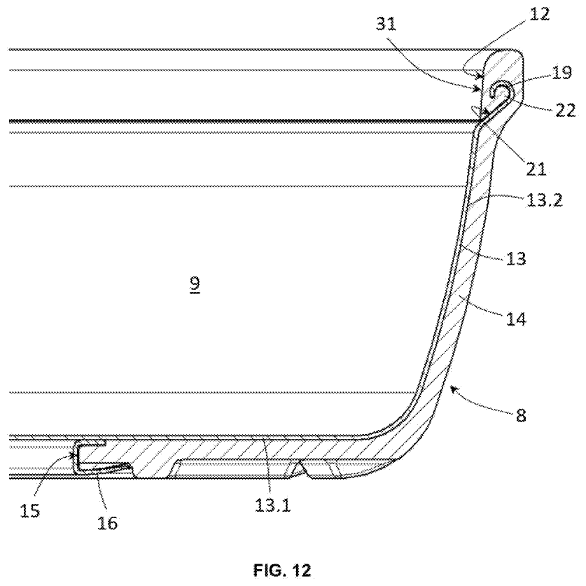

As shown more specifically in FIG. 11, the bowl 8 comprises a bowl body 13 which is metallic, for example stainless steel, iron, or similar, and which delimits at least part of the internal volume 9 of the bowl 8, and a thermal insulation coating 14 which is a thermally insulating material, for example elastomer, and which covers at least part of an external surface of the bowl body 13. Advantageously, the thermally insulating material is transparent to the magnetic field generated by the lower heating device 6.

The bowl body 13 comprises a bottom wall 13.1 and a peripheral wall 13.2 extending upwards from the bottom wall 13.1, and the thermal insulation coating 14 covers at least part of an outer surface of the peripheral wall 13.2 of the bowl body 13 and at least part of an outer surface of the bottom wall 13.1 of the bowl body 13. The thermal insulation coating 14 includes an underside configured to rest on the receiving surface 5.

Advantageously, the thermal insulation coating 14 completely covers the outer surface of the peripheral wall 13.2 of the bowl body 13, and comprises a lower opening 15 (see in particular FIG. 11) located opposite the bottom wall 13.1 of the bowl body 13 and configured to expose a central portion of the bottom wall 13.1 of the bowl body 13. According to the embodiment shown in the figures, the bowl 8 comprises a metallic insert 16 which is attached by welding or bonding to the bottom wall 13.1 of the metallic bowl body 13. The metallic insert 16 has a part which, in the first stage of the manufacturing process for the bowl 8, is inserted into the inner opening 15 before being folded against the lower surface of the thermal insulation coating 14, thereby clamping the latter against the bottom wall 13.1 in order to keep it in position and ensure a waterproof connection between the metallic insert 16 and the thermal insulation coating 14.

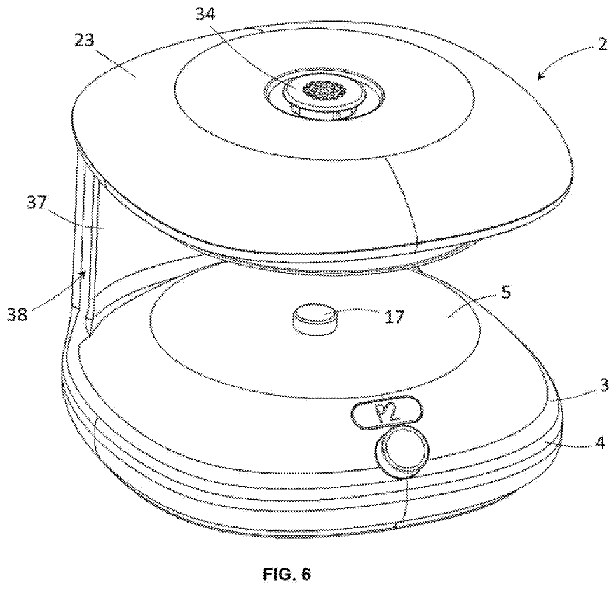

As shown in FIGS. 4 and 6, the base 3 comprises a centering member 17 protruding upwards from the receiving surface 5, and the bowl 8 comprises a centering housing 18 which is formed by the metallic insert 16 and the bottom wall 13.1 of the bowl body 13 and which is configured to receive the centering member 17 when the bowl 8 is resting on the receiving surface 5. Such a configuration of the base 3 and the bowl 8 ensures an optimal relative position of the bowl 8 compared to the lower heating device 6, and in particular compared to the induction coil 7.

For example, the centering member 17 may be formed by a temperature sensor belonging to the lower heating device 6 and configured to monitor the temperature of the bowl body 13. Advantageously, the centering member 17, and therefore the temperature sensor, is configured to be in contact with the bottom wall 13.1 of the bowl body 13 when the bowl 8 is resting on the receiving surface 5.

As shown more specifically in FIG. 12, the thermal insulation coating 14 covers an upper end of the peripheral wall 13.2 of the bowl body 13, and also partially covers the inner surface of an upper end portion of the peripheral wall 13.2 of the bowl body 13. Advantageously, the thermal insulation coating 14 extends over the entire inner perimeter of the upper end portion of the peripheral wall 13.2 of the bowl body 13, completely delimits the upper opening 12 of the bowl 8 and forms the upper peripheral edge 11 of the bowl 8.

According to the embodiment shown in the figures, the upper end portion of the peripheral wall 13.2 of the bowl body 13 delimits a retaining housing 19, for example annular, such as an annular retaining groove, with an insertion opening 21, for example annular, which leads into the bowl body 13, and the thermal insulation coating 14 comprises a retaining part 22, for example annular, such as an annular retention bead, which is received and retained in the retaining housing 19.

The food-heating appliance 2 also has a lid 23 supported by the base 3 and configured to sit on top of the bowl 8, i.e. to extend over the bowl 8, when the bowl 8 is resting on the receiving surface 5.

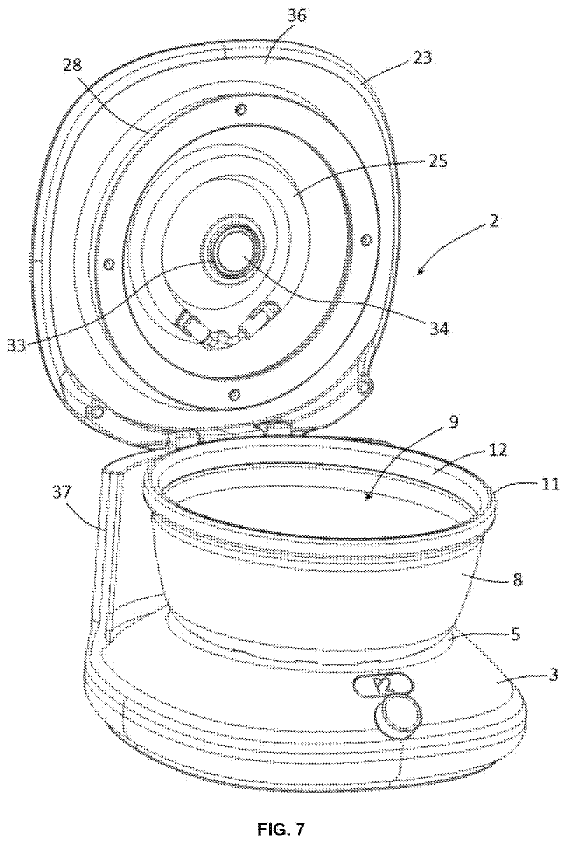

According to the embodiment shown in the figures, the lid 23 is mounted to pivot relative to the base 3 around a pivot axis and between a closed position (see FIG. 1), in which the lid 23 is configured to cover the bowl 8 and to prevent access to the internal volume 9 of the bowl 8 when the bowl 8 is resting on the receiving surface 5, and an open position (see FIG. 7), in which the lid 23 is configured to allow access to the internal volume 9 of the bowl 8 when the bowl 8 is resting on the receiving surface 5. Advantageously, the open position of the lid 23 is stable, and the pivot axis extends substantially horizontally when the base 3 is resting on a horizontal surface.

The lid 23 is more particularly configured such that, when the lid 23 is in the closed position and the bowl 8 is resting on the receiving surface 5, a central axis of the lid 23 is substantially aligned with a central axis of the bowl 8, and such that, when the lid 23 is in the open position and the bowl 8 is resting on the receiving surface 5, the central axis of the lid 23 is not intersecting with the bowl 8.

As shown in FIG. 4, the lid 23 comprises a lid body 24 and an upper heating element 25 attached to the lid body 24. The upper heating element 25 is more particularly configured to heat by infrared radiation a food contained in the internal volume 9 of the bowl 8. Advantageously, the upper heating element 25 is an electric heating resistor, and is configured to extend facing the bottom wall 13.1 of the bowl body 13 when the lid 23 is in the closed position and the bowl 8 is resting on the receiving surface 5. For example, the upper heating element 25 can extend at least partially around the central axis of the lid 23.

According to one embodiment of the invention, the food-heating appliance 2 could be equipped with a switch (not shown in the figures) configured to detect a movement of the lid 23 to the open position, and the food-heating appliance 2 could be configured to cut off the electrical power supply of the upper heating element 25 when the switch detects a movement of the lid 23 to the open position. Such a feature has the advantage of limiting the user's discomfort and the risk of burns related to the radiation of the upper heating element 25 when the lid 23 is in the open position.

According to the embodiment shown in the figures, the lid 23 also comprises a reflector 26 attached to the lid body 24 and configured to deflect at least part of the radiation of the upper heating element 25 to the bowl 8 when the lid 23 is in the closed position and the bowl 8 is resting on the receiving surface 5. Advantageously, the reflector 26 is configured to extend above the upper heating element 25 when the lid 23 is in the closed position.

According to the embodiment shown in the figures, the lid 23 also comprises a protective element 27, such as a protective plate or grid, attached to the lid body 24 and configured to prevent a user from accessing the upper heating element 25, in particular when the lid 23 is in the open position. The protective element 27 is configured to extend under the upper heating element 25 and substantially horizontally when the lid 23 is in the closed position and the base 3 is resting on a horizontal surface. According to the embodiment shown in the figures, the protective element 27 is substantially transparent to the wavelengths of the radiation emitted by the upper heating element 25, and may, for example, be made of glass or ceramic glass. Advantageously, the reflector 26 and the protective element 27 delimit an internal housing, for example annular, in which the upper heating element 25 is arranged.

As shown in FIG. 4, the lid 23, and more specifically the lid body 24, comprises a part of the thermal shield portion 28 configured to extend downwards and to protrude into the bowl 8 when the lid 23 is in the closed position and the bowl 8 is resting on the receiving surface 5. In other words, when the lid 23 is in the closed position and the bowl 8 is resting on the receiving surface 5, the thermal shield portion 28 and the receiving surface 5 are spaced apart by a separation distance that is less than the height of the bowl 8.

The thermal shield portion 28 is more particularly configured such that, when the lid 23 is in the closed position and the bowl 8 is resting on the receiving surface 5, the upper peripheral edge 11 of the bowl 8 is not directly subjected to the infrared radiation of the upper heating element 25.

As shown in FIG. 4, the thermal shield portion 28 has an overall cylindrical shape, and is configured to extend between the upper peripheral edge 11 of the bowl 8 and the upper heating element 25. The thermal shield portion 28 comprises an external circumferential surface 29 configured to extend opposite an internal circumferential surface 31 of the bowl 8, and more specifically an upper part of the side wall 8.2 of the bowl 8. Advantageously, the food-heating appliance 2 is configured so that, when the lid 23 is in the closed position and the bowl 8 is resting on the receiving surface 5, a central axis of the thermal shield portion 28 is aligned with the central axis of the bowl 8.

The thermal shield portion 28 has an external diameter that is less than an internal diameter of the upper peripheral edge 11 of the bowl 8. Thus, the thermal shield portion 28 and the bowl 8 are configured to delimit a space 32, advantageously annular, extending around the thermal shield portion 28. Advantageously, the space 32 has a width, measured in a radial direction relative to a central axis of the bowl 8, between 2 mm and 4 cm, and for example between 2 mm and 1 cm.

According to the embodiment shown in the figures, the lid 23 also comprises a steam exhaust chimney 33 configured to evacuate, towards the outside of the food-heating appliance 2, the steam generated in the internal volume 9 of the bowl 8. The presence of such a steam exhaust chimney 33 makes it possible to reduce the steam pressure in the bowl 8, and therefore the risk of steam escaping by the upper peripheral edge 11 of the bowl 8, which further limits the risks of heating the upper peripheral edge 11 of the bowl 8.

As shown in FIG. 4, the steam exhaust chimney 33 is arranged in a central part of the lid 23, and the upper heating element 25 extends around the steam exhaust chimney 33. The steam exhaust chimney 33 can, for example, have a cross-section that is overall circular. Advantageously, the steam exhaust chimney 33 is configured to extend substantially vertically when the lid 23 is in the closed position and the base 3 is resting on a horizontal surface, and the protective element 27 comprises a central opening 27.1 configured to fluidly connect the internal volume 9 of the bowl 8 to the steam exhaust chimney 33.

According to the embodiment shown in the figures, the lid body 24 comprises a central passage forming the steam exhaust chimney 33 and comprising a first passage end leading into an underside of the lid 23 and a second passage end leading into an upper side of the lid 23, and the lid 23 comprises a lid insert 34 which is mounted removably in the central passage.

The lid insert 34 more specifically comprises a tubular steam-guiding portion 34.1 configured to be fluidly connected to the internal volume 9 of the bowl 8, and an upper end wall 34.2 that partially closes one upper end of the steam-guiding portion 34.1, and which is provided with several steam evacuation openings 34.3.

According to the embodiment shown in the figures, the lid 23 comprises a peripheral closure part 35 configured to cooperate, for example in a sealed manner, with the bowl 8 and in particular with the upper part of the side wall 8.2 of the bowl 8, so as to prevent hot air from flowing between the upper peripheral edge 11 of the bowl 8 and the thermal shield portion 28.

The lid 23 also has a prominent gripping part 36 which is configured to be grasped by a user when moving the lid 23 between the open position and the closed position. The prominent gripping part 36 is configured to protrude, and in particular to extend radially, beyond the side wall 8.2 of the bowl 8 when the lid 23 is in the closed position and the bowl 8 is resting on the receiving surface 5. For example, the prominent gripping part 36 can be configured to protrude beyond the side wall of the bowl by a protrusion distance D which is greater than 1 cm.

Advantageously, the prominent gripping part 36 extends over at least part of the perimeter of the lid 23. The prominent gripping part 36 may, for example, extend from a first lateral side of the lid 23 to a second lateral side of the lid 23 through a front part of the lid 23, in particular to allow easy and safe gripping of the lid 23 by a user situated in front of the food-heating appliance 2.

As shown in FIG. 5, the prominent gripping part 36 comprises an underside, for example substantially flat, which is configured to be located above and at least partially opposite the upper peripheral edge 11 of the bowl 8 when the lid 23 is in the closed position and the bowl 8 is resting on the receiving surface 5. Advantageously, the lid 23 is configured so that the underside of the prominent gripping part 36 is located away from the upper peripheral edge 11 of the bowl 8 when the lid 23 is in the closed position and the bowl 8 is resting on the receiving surface 5.

According to the embodiment shown in the figures, the base 3 comprises a support structure 37 which extends upward from the main housing 4 and which is configured to support the lid 23. Advantageously, the support structure 37 is located in a rear part of the base 3, and is configured to extend substantially vertically when the base 3 is resting on a horizontal surface.

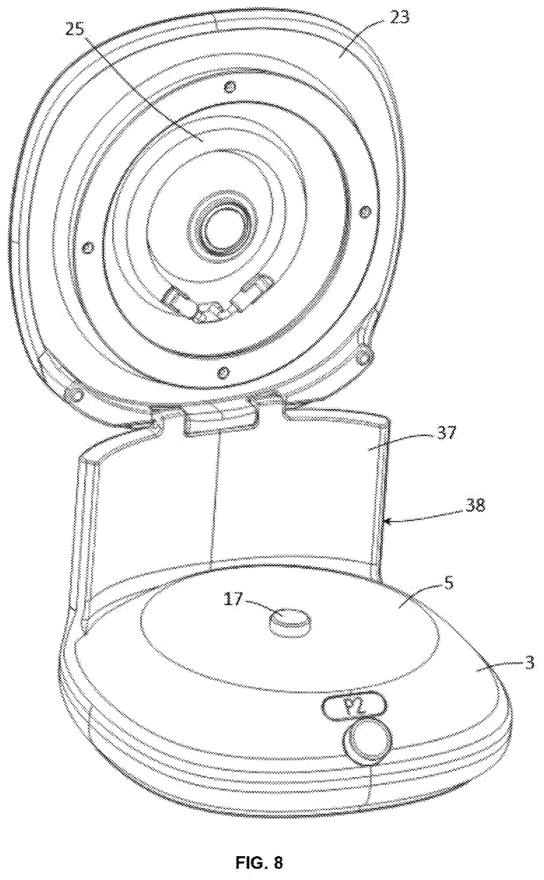

As shown in FIG. 8, the support structure 37 has a cross-section, according to a plane perpendicular to the central vertical axis of the base 3, which is substantially arc-shaped, and extends only along a part of the perimeter of the main housing 4. The support structure 37 is configured to extend only around part of the periphery of the bowl 8 when the bowl 8 is resting on the receiving surface 5 of the base 3. Advantageously, the support structure 37 extends over an angular sector centered on the central vertical axis of the base 3 and having an angle between, for example, 60° and 120°.

The support structure 37 is more specifically configured to provide an access opening 38 which is configured to allow access to the bowl 8 and to allow the bowl 8 to be placed and removed by at least one translational movement parallel to a plane of extension of the receiving surface 5. The access opening 38 extends over at least 180°, and for example over at least 240°, from the periphery of the bowl 8 when the bowl 8 is resting on the receiving surface 5. Thus, the access opening 38 is configured so that at least 50% of the circumference of the side wall 8.2 of the bowl 8 is exposed, that is to say, is directly accessible to a user, when the bowl 8 is resting on the receiving surface 5. Such a configuration of the access opening 38 allows, in particular, a firm two-handed grip of the bowl 8 by a user, with a view to removing the bowl 8 from the receiving surface 5, especially when the lid 23 is in the open position. Advantageously, the access opening 38 has a height greater than the height of the bowl 8, and is configured so that the bowl portion, which is accessible through the access opening 38 when the bowl 8 is resting on the receiving surface 5, is exposed throughout its height.

According to the embodiment shown in the figures, the access opening 38 is configured to allow access to the bowl 8 resting on the receiving surface 5 from a first side of the food-heating appliance 2, from a second side of the food-heating appliance 2, and also from a front part of the food-heating appliance 2.

The food-heating appliance 2 also has a control unit 39 configured to control the operation of the food-heating appliance 2, and a human-machine interface 41 configured to allow a user to select at least one operating parameter of the food-heating appliance 2. Advantageously, the control unit 39 is arranged in the main housing 4 of the base 3, and the human-machine interface 41 is arranged in a front part of the main housing 4 of the base 3.

An example of a food cooking process using the food-heating appliance 2 according to the present invention is described below.

Such a cooking process comprises the following steps:
movement of the lid 23 to the open position,
positioning of the bowl 8 on the receiving surface 5,
insertion of the food to be cooked in the internal volume 9 of the bowl 8,
movement of the lid 23 to the closed position,
selection of operating parameters, for example the cooking temperature and cooking time, using the human-machine interface 41, and
cooking of the food according to the selected operating parameters.

When the cooking of the food is complete, the user grasps the prominent gripping part 36 and safely moves the lid 23 into the open position, and then firmly grips the bowl 8, with one or both hands, and transports it to the dining location.

The specific configuration of the access opening 38, allows a user, in particular, who wishes to remove the bowl 8 from the receiving surface 5 at the end of cooking, to firmly grasp the bowl with one or both hands and extract it from the receiving surface 5 according to various orientations, thereby enhancing the ergonomics of the food-heating appliance 2 according to the present invention.

During the transport of the bowl 8 to the dining location, if the user has grasped the bowl 8 with both hands, the palms of the user's hands are in contact with the outer surface of the thermal insulation coating 14, and are therefore not directly in contact with the bowl body 13 which has a high temperature. When the user transports the bowl 8 with one hand, he/she usually positions the palm of the hand carrying the bowl 8 in contact with the outer surface of the thermal insulation coating 14 and the thumb of the hand carrying the bowl 8 against the inner circumferential surface of the upper part of the side wall 8.2 of the bowl, in order to ensure a firm grip of the bowl 8. However, since the thermal insulation coating 14 defines such an internal circumferential surface, the user's thumb is not directly in contact with the bowl body 13 which, as indicated above, has a high temperature.

Thus, the specific configuration of the bowl 8 according to the present invention avoids any risk of burns to the user when transporting the bowl 8 after cooking the food contained in it.

In addition, when consuming their meal, the user is not likely to get burned since the upper peripheral edge 11 of the bowl 8 has a low temperature because, during the cooking step of the food, the upper peripheral edge 11 of the bowl 8 is not directly subjected to infrared radiation from the upper heating element 25.

According to one embodiment of the invention not shown in the figures, the thermal insulation coating 14 could be attached to the bowl body 13 by overmolding or bonding.

According to one embodiment of the invention not shown in the figures, the thermal insulation coating 14 could be removable from the bowl body 13.

According to one embodiment of the invention not shown in the figures, the lid 23 could be fixed relative to the base 3 and have an underside located opposite the receiving surface 5 provided on the base 3.

According to one embodiment of the invention not shown in the figures, the lid 23 could be mounted so as to be movable in a translational movement relative to the main housing 4 of the base 3 in a direction of movement that is substantially vertical when the base 3 is resting on a horizontal surface.

According to one embodiment of the invention not shown in the figures, the lower heating device 6 could be a convection heating device, a conduction heating device, or a radiation heating device. According to such an embodiment of the invention, the lower wall of the bowl body 13 is exposed, i.e., not covered by the thermal insulation coating 14, so as to allow heating of the bowl body 13 by the lower heating device 6.

According to one embodiment of the invention, the food-heating appliance 2 could comprise a fan mechanically connected to the lid 23 and configured to generate an airflow, and the upper heating element 25 would be configured to heat the air-flow generated by the fan.

Of course, the present invention is in no way limited to the embodiment described and illustrated, since this embodiment was only provided by way of example. Changes can still be made, particularly with regard to the constitution of the various elements or by substituting technical equivalents, without departing from the scope of protection of the invention.

1. A food-heating appliance comprising:
a base including a receiving surface,
a bowl (8) which is removable and configured to rest on the receiving surface of the base, the bowl comprising a bottom and a side wall which delimit an internal volume intended to contain food, the side wall of the bowl comprising an upper peripheral edge delimiting an upper opening through which food can be introduced into the internal volume of the bowl;
a lid supported by the base and configured to sit on top of the bowl when the bowl is resting on the receiving surface, the lid comprising an upper heating element configured to heat, at least by radiation, food contained in the bowl; and
wherein the lid comprises a thermal shield portion configured to be arranged inside the bowl when the bowl is resting on the receiving surface so that the upper peripheral edge of the bowl is not directly subjected to radiation from the upper heating element.

2. The food-heating appliance of claim 1, wherein the thermal shield portion is configured to extend between the upper peripheral edge of the bowl and the upper heating element.

3. The food-heating appliance of claim 1, wherein the thermal shield portion comprises an external circumferential surface configured to extend facing an internal circumferential surface of the bowl.

4. The food-heating appliance of claim 1, wherein the thermal shield portion has an overall cylindrical shape.

5. The food-heating appliance of claim 1, wherein the thermal shield portion and the bowl are configured to delimit a space extending around the thermal shield portion.

6. The food-heating appliance of claim 1, wherein the lid comprises a protective element configured to prevent a user from accessing the upper heating element, the protective element being configured to extend under the upper heating element when the food-heating appliance is in use.

7. The food-heating appliance of claim 1, wherein the base comprises a lower heating device configured to heat food contained in the bowl when the bowl is resting on the receiving surface.

8. The food-heating appliance of claim 1, wherein the lid comprises a steam exhaust chimney configured to evacuate, to the outside of the food-heating appliance, steam generated in the internal volume of the bowl.

9. The food-heating appliance of claim 1, wherein the bowl comprises:
a bowl body delimiting at least in part the internal volume of the bowl; and
at least one thermally insulating layer that envelops at least in part the bowl body.

10. The food-heating appliance of claim 9, wherein the thermally insulating layer comprises a thermal insulation coating which is made of thermally insulating material and which covers at least part of an external surface of the bowl body.

11. Food-heating appliance according to claim 10, wherein the thermal insulation coating covers an upper end of the bowl body and at least partially delimits the upper opening of the bowl.

12. The food-heating appliance of claim 1, wherein the lid is movable between a closed position in which the lid is configured to cover the bowl and to prevent access to the internal volume of the bowl when the bowl is resting on the receiving surface, and an open position in which the lid is configured to allow access to the internal volume of the bowl when the bowl is resting on the receiving surface.

13. The food-heating appliance of claim 1, wherein the base comprises:
a main housing on which the receiving surface is provided; and
a support structure that extends upward from the main housing and is configured to support the lid, the support structure being configured to extend only along part of the periphery of the bowl when the bowl is resting on the receiving surface of the base.

14. The food-heating appliance of claim 13, wherein the support structure is configured to provide an access opening extending over at least 180° of the periphery of the bowl when the bowl is resting on the receiving surface.

15. The food-heating appliance of claim 1, wherein the internal volume of the bowl is less than 1.3 liters.
